(19) United States
(12) Patent Application Publication
(10) Pub. No.: US 2013/0271834 A1
(43) Pub. Date: Oct. 17, 2013

(54) WIRE GRID POLARIZER

(71) Applicants: Jin Su Kim, Seoul (KR); Kyoung Jong Yoo, Seoul (KR); Young Jae Lee, Seoul (KR); Jun Lee, Seoul (KR)

(72) Inventors: Jin Su Kim, Seoul (KR); Kyoung Jong Yoo, Seoul (KR); Young Jae Lee, Seoul (KR); Jun Lee, Seoul (KR)

(73) Assignee: LG INNOTEK CO., LTD., Seoul (KR)

(21) Appl. No.: 13/976,320

(22) PCT Filed: Oct. 11, 2011
(86) PCT No.: PCT/KR2011/007514

§ 371 Date: Jun. 26, 2013

(30) Foreign Application Priority Data
Dec. 27, 2010 (KR) 10-2010-0135675

(51) Int. Cl. G02B 5/30

(52) U.S. Cl. CPC G02B 5/3058
USPC 359/485.05

(57) ABSTRACT

Provided is a wire grid polarizer including: a first grid patterns on a substrate; a second grid pattern on the first grid patterns; and a passivation layer filling between the first grid patterns and the second grid patterns.

### TECHNICAL FIELD

The present invention relates to a structure of a wire grid polarizer, which can provide stable color coordinates, and a method for manufacturing the same.

### BACKGROUND ART

A polarizer or a polarizing device refers to an optical device that extracts linearly polarized light having a specific propagation direction among non-polarized light such as natural light. In general, when the period of a metal wire arrangement is shorter than half the wavelength of incident electromagnetic wave, a polarization component (S wave) parallel to a metal wire is reflected and a polarization component (P wave) perpendicular to a metal wire is transmitted. The use of this phenomenon makes it possible to manufacture a planar polarizer having excellent polarization efficiency, high transmittance, and wide viewing angle. This device is referred to as a wire grid polarizer.

FIG. 1 illustrates the structure and function of a conventional wire grid polarizer. Metal grids 2 having a constant height h are arranged on a substrate 1 at a constant period A. In such a wire grid polarizer, the period of fine metal grids is set to be equal to or less than half the wavelength of visible light. In the case where the period of the fine metal grids is sufficiently smaller than the wavelength of incident light, when non-polarized light is incident, the wire grid polarizer transmits a P wave, which is a component having a vector perpendicular to a conductive wire grid, and reflects an S wave, which is a component having a vector parallel to a wire grid.

In such a conventional wire grid polarizer, as incidence angle of light is increased by the fine metal grids formed just above the substrate, transmittance is varied according to the wavelength of the incident light. Therefore, when color reproduction according to the viewing angle is limited or light is incident on an opposite surface of the substrate 1 on which the metal grids are formed, transmittance of light is lowered by light reflection and absorption that occur on the substrate 1.

To solve such problems, as illustrated in FIG. 2, an effort has been made to minimize light loss of a polarizing plate by providing a cover layer 3 on the top surfaces of metal grids 2 formed on the substrate 1, and forming pores 4 being an air layer having low refractive index in a space between the respective metal grids 2.

However, this structure requires vacuum processes, such as a PE-CVD process, a sputtering process, and an evaporation process, in order to maintain the pores 4 between the metal grids 2. The presence of the pores 4 has a structural weakness that causes the wire grid polarizer to be deformed or damaged at high temperature environment or by external environment change.

### DISCLOSURE OF INVENTION

### Technical Problem

An aspect of the present invention is directed to a wire grid polarizer, which includes first grid patterns and second grid patterns on a transparent substrate, and a passivation layer between the respective patterns. Thus, transmittance of each wavelength according to an incidence angle of incident light is controlled to minimize a color change rate according to an observation angle and improve anti-scratch characteristic and anti-corrosion characteristic that are generated from the physical limits of nano-size fine patterns.

### Solution to Problem

According to an embodiment of the present invention, a wire grid polarizer includes: a plurality of first grid patterns formed on a transparent substrate; a plurality of second grid patterns formed of a metal on the first grid patterns; and a passivation layer filling a space between the first grid patterns and the second grid patterns, wherein the period of the first grid patterns or the second grid patterns ranges from 50 nm to 200 nm.

According to another embodiment of the present invention, a wire grid polarizer includes: a passivation layer stacked on a transparent substrate; and one or more second grid patterns spaced apart from the surface of the transparent substrate and buried within the passivation layer. In this case, the period of the second grid patterns may range from 50 nm to 200 nm, and the width of the second grid patterns may range from 2 nm to 300 nm.

The wire grid polarizer according to the present invention may be manufactured by the following processes.

The method for manufacturing the wire grid polarizer includes: forming a first grid layer having a plurality of first grid patterns on a transparent substrate; depositing a metal layer on the first grid layer; etching the metal layer to form a plurality of second grid patterns on the first grid patterns; and forming a passivation layer burying the second grid patterns.

### Advantageous Effects of Invention

According to the present invention, the wire grid polarizer includes first grid patterns and second grid patterns on a transparent substrate, and a passivation layer filling a space between the respective patterns. Thus, transmittance of each wavelength according to an incidence angle of incident light is controlled to minimize a color change rate according to an observation angle and improve anti-scratch characteristic and anti-corrosion characteristic that are generated from the physical limits of nano-size fine patterns.

### BRIEF DESCRIPTION OF DRAWINGS

The above and other aspects, features and advantages of certain exemplary embodiments of the present invention will be more apparent from the following description taken in conjunction with the accompanying drawings, in which:

FIGS. 1 and 2 are cross-sectional conceptual diagrams explaining a structure and an operation principle of a conventional wire grid polarizer;

FIGS. 3A to 3F are cross-sectional views illustrating a method for manufacturing a wire grid polarizer according to the present invention;

FIGS. 4A and 4B are cross-sectional conceptual diagrams illustrating a structure of the wire grid polarizer according to the present invention;

FIG. 5 is a graph showing a simulation result about the efficiency of the wire grid polarizer according to the present invention; and

FIGS. 6 and 7 are diagrams illustrating a wire grid polarizer according to another embodiment of the present invention.

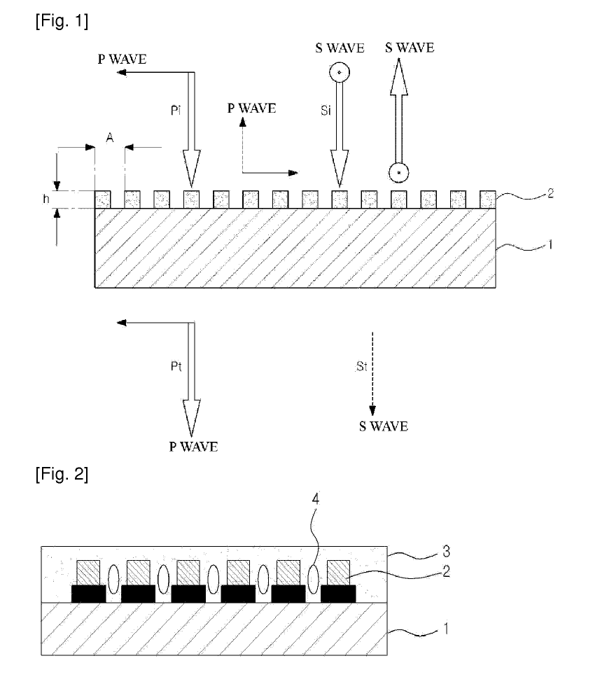

### REFERENCE NUMERALS

110: substrate

120: first grid layer

121: first grid pattern

131: second grid pattern

140: surface treatment layer

### Mode for the Invention

Exemplary embodiments of the present invention will be described below in detail with reference to the accompanying drawings. Wherever possible, the same reference numerals will be used to refer to the same elements throughout the specification, and a duplicated description thereof will be omitted. It will be understood that although the terms first, second, etc. are used herein to describe various elements, these elements should not be limited by these terms. These terms are only used to distinguish one element from another element.

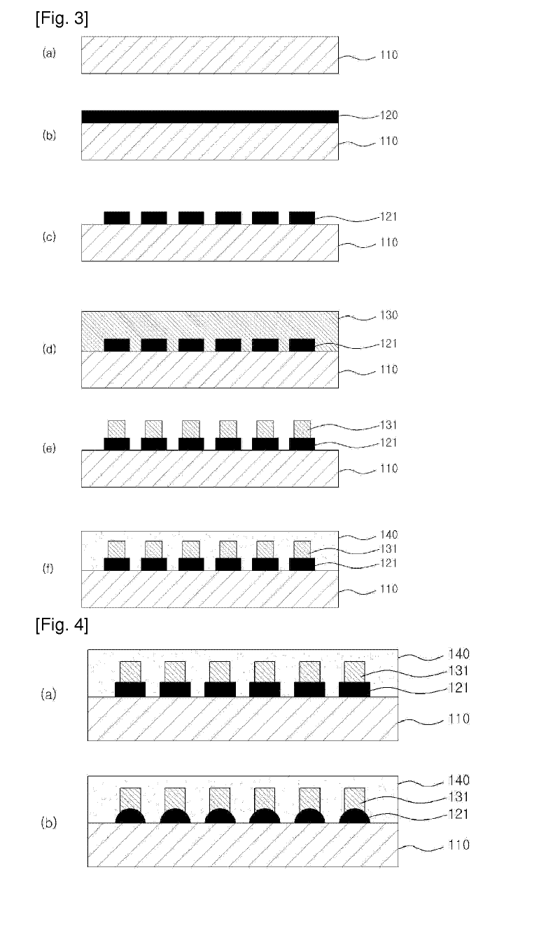

FIGS. 3A to 3F are cross-sectional views illustrating a method for manufacturing a wire grid polarizer according to the present invention, and FIGS. 4A and 4B are cross-sectional conceptual diagrams illustrating a structure of the wire grid polarizer according to the present invention.

Referring to FIGS. 3(a) to 3(c), a resin material layer 120 is formed a transparent substrate 110, and a first grid layer including a plurality of first grid patterns 121 is formed using the resin material layer 120 as a mold.

Referring to FIGS. 3(d) and 3(e), a metal layer 130 is deposited on the first grid layer, and the metal layer 130 is etched to form second grid patterns 131 on the top surfaces of the first grid patterns 121.

Referring to FIG. 3(f), a passivation layer 140 is formed to bury the second grid patterns 131. In this manner, the manufacturing process is completed.

Referring to FIGS. 4A and 4B, the wire grid polarizer according to the present invention includes the plurality of first grid patterns 121 on the transparent substrate, and the second grid patterns 131 formed of a metal on the first grid patterns 121, and a passivation layer 140 is formed to fill the space between the first grid patterns and the second grid patterns. In particular, in this case, it is preferable that the period of the first grid patterns 121 ranges from 50 nm to 200 nm.

That is, the space between the first grid patterns and the second grid patterns, which has no patterns, is filled with a polymer or oxide to thereby minimize a change of light, and it is possible to ensure reliability even in high-temperature and high-humidity environment because no air layers (pores) are inserted. In particular, by forming the first grid patterns 121 within the period range of 50 nm to 200 nm, the balance of a visible light region can be ensured and a white balance can be maintained. If the period of the first grid patterns 121 is less than 50 nm or greater than 200 nm, red, green and white light are unbalanced.

In particular, the passivation layer 140 may be higher than the second grid patterns 131. It is preferable that the first grid patterns 121 and the second grid patterns 131 are formed to have a width and height to maximize transmittance and polarization efficiency. In this case, it is preferable that the first grid has 0.2-1.5 times the width of the second grid pattern. Specifically, it is preferable that the width to height ratio of the first grid pattern 121 ranges from 1:0.2 to 1:5, and it is preferable that the width (w) of the first grid pattern 121 ranges from 10 nm to 200 nm and the height (h1) of the first grid pattern 121 ranges from 10 nm to 500 nm.

Transmittance may be adjusted according to the height and width of the two grids (first and second grid patterns). If the grid width is widened at the same pitch, the transmittance is lowered and the polarization extinction ratio is increased. To ensure the maximum polarization efficiency, the polarization characteristic is increased as the pitch is decreased. In the case where the grids are formed at the same distance and same width, the polarization characteristic is improved as the grid height is increased. In the case where the grids are formed at the same distance and same height, the polarization characteristic is improved as the grid width is increased. In two grid patterns of the above-described category, the polarization characteristic can be maximized.

The second grid patterns 131 may be provided with a plurality of metal grid patterns on the first grid patterns 121. The second grid patterns 131 may be implemented by forming a metal layer on the first grid patterns by a deposition process and etching the metal layer.

In addition, the second grid patterns 131 have a structure in which fine protrusion patterns formed of a metal are arranged at a constant period. In particular, the second grid patterns 131 may be formed on the top surfaces of the first grid patterns 121 through a deposition process or the like by using any one metal selected from aluminum, chromium, silver, copper, nickel, and cobalt, or an alloy thereof. The period refers to a distance between one metal grid pattern (second grid pattern) and an adjacent metal grid pattern (second grid pattern).

In addition, the cross section of the second grid pattern 131 may have various shapes, for example, a rectangular shape, a triangular shape or a semicircular shape, or may have a metal wire shape that is partially formed on a substrate patterned in a shape of triangle, rectangle, or sinusoidal wave. That is, any metal wire grids may be used as long as they are arranged in one direction at a constant period, regardless of the cross-sectional structure. In this case, the period may be equal to or less than half the wavelength of light used. Therefore, the period may range from 50 nm to 200 nm. In addition, in a preferred embodiment of the present invention, the width to height ratio of the second grid pattern 131 may range from 1:0.5 to 1:1.5. In particular, the width ratio of the first grid pattern to the second grid pattern may range from 1:0.2 to 1:1.5. Specifically, the width of the second grid pattern may range from 2 nm to 300 nm.

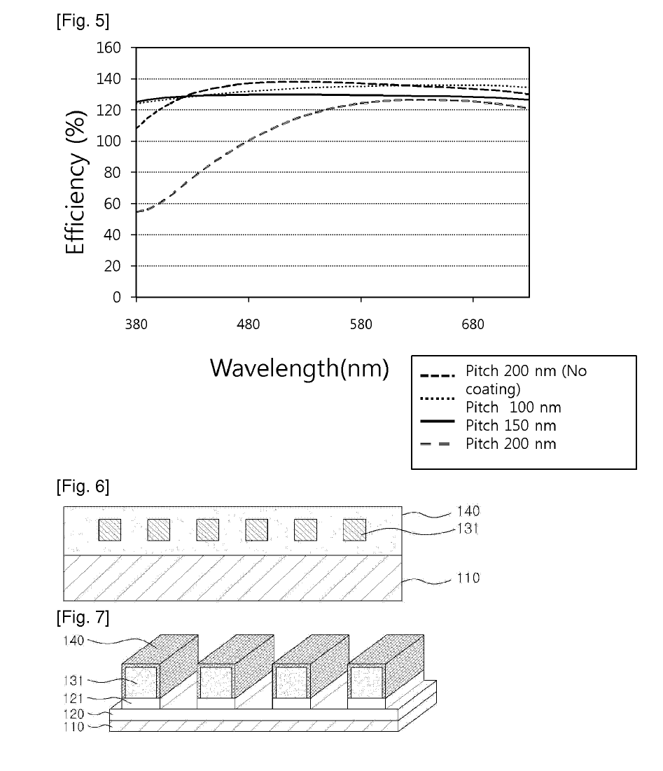

FIG. 5 is a graph showing a simulation result of light efficiency according to the period of the first grid patterns or the second grid patterns according to the present invention.

Referring to the simulation result of FIG. 5, in the case where the period is 200 nm, the efficiency of a short-wavelength side is greatly lowered if the passivation layer is formed. In the case where the period is the same as the period of the first grid patterns or the second grid patterns according to the present invention, that is, in the range from 50 nm to 200 nm, especially 150 nm or less, the white balance can be set even though the passivation layer according to the present invention is formed. That is, the passivation layer having no color change can be implemented through the period design of the first grid patterns or the second grid patterns according to the present invention.

FIG. 6 is a diagram illustrating a wire grid polarizer according to another embodiment of the present invention.

A passivation layer 140 is formed on a transparent substrate 110, and second grid patterns 131 formed of a metal are spaced apart on the transparent substrate. The second grid patterns 131 may be buried within the passivation layer 140.

In this case, the period, material, width and area of the second grid patterns 131 may be equal to the ranges set forth in the embodiment of FIG. 3. This structure is formed when the passivation layer is formed of the same material as the polymer or oxide used to form the first grid patterns in the embodiment of FIG. 3.

FIG. 7 is a diagram illustrating a wire grid polarizer according to another modification of the present invention, prior to the formation of the passivation layer in FIG. 3.

In the illustrated structure, the surface treatment layer 140 is formed on the first grid patterns 121 or the second grid patterns 131. It is apparent that in the case where the passivation layer is formed of the same material as the first grid patterns as illustrated in FIG. 6, the second grid patterns 131 with the surface treatment layer 140 are buried within the passivation layer.

In the structure of FIG. 7, in order to improve the durability and strength, the surface treatment layer 140 may be formed by being surface-treated by any one of an atmospheric pressure plasma treatment, a vacuum plasma treatment, a peroxide treatment, a pro-oxidant treatment, an anticorrosive treatment, and a self-assembly monolayer (SAM) coating.

In particular, as illustrated in FIG. 7, in the case where the surface treatment layer is formed to cover the whole second grid patterns and the attachment region between the first grid patterns and the second grid patterns, an oxide film or a similar surface treatment film causing no deformation in the surface of each grid pattern and improving the durability is provided to implement physical properties that do not degrade optical characteristics and improve adhesion between the second grid patterns and the polymer layer of the first grid patterns.

In addition, the surface treatment may be achieved by performing a blackening process on the second grid patterns 131. The blackening layer may be formed by blackening a partial or entire portion of the second grid patterns 131 using an organic material or an inorganic material. That is, the blackening layer may be formed at a partial or entire portion of the second grid patterns 131.

Specifically, the blackening according to a preferred embodiment of the present invention refers to a formation of a cover layer that covers the surface of the second grid patterns 131 using an organic material or an inorganic material. More preferably, the surface reflectivity of the substrate may be set to be equal to or less than 40% due to the blackening layer.

Examples of the organic material for the blackening include a chromium oxide or a carbon-containing material, and the inorganic material may be treated by an oxidizing process on copper. That is, in the case of the inorganic material, copper is deposited on the above-described metal grid pattern and is etched so that only copper is formed partially or entirely on the metal grid pattern. Then, a wet or dry metal oxidation (blackening) process is performed for blackening copper. Alternatively, the blackening layer may be formed by depositing chromium on the metal grid pattern and etching the deposited chromium so that chromium is formed partially or entirely on the metal grid pattern. The blackening layer remarkably reduces a surface re-reflection ratio of light incident from the exterior, which further improves a contrast ratio and readability.

The wire grid polarizer of FIG. 3 according to the present invention may be manufactured in the following order.

Specifically, the method for manufacturing the wire grid polarizer may include: a first process of forming a first grid layer with a plurality of first grid patterns on a transparent substrate; a second process of depositing a metal layer on the first grid layer; a third process of patterning the metal layer to form a plurality of second grid patterns on the first grid patterns; and a fourth process of forming a passivation layer burying the second grid patterns.

That is, the example of the structure illustrated in FIGS. 3 to 5 may be manufactured in the above-described order. In particular, the period of the first grid patterns or the second grid patterns may range from 50 nm to 200 nm, and the width, the height, and the width to height ratio of the first grid patterns and the second grid patterns may be equal to those of the above-described embodiment. As one example, the width of the first grid patterns may range from 10 nm to 200 nm, the height of the first grid patterns may range from 10 nm to 500 nm, and the width to height ratio of the first grid patterns may range from 1:0.2 to 1:5. In the third process, the metal layer may be etched by a wet etching process, such that the width of the second grid patterns ranges from 2 nm to 300 nm, or the width ratio of the first grid pattern to the second grid pattern ranges from 1:0.2 to 1:1.5.

In particular, preferably, in the fourth process of the present invention, the passivation layer filling the space between the first grid patterns and the second grid patterns may be formed by coating a liquid resin of the same material as the first grid patterns or a liquid resin of different materials from the first grid patterns. It is preferable to use a liquid resin in order to implement a structure having no pores or bubbles by forming an efficient filling structure in a space between patterns having a nano-size width and period. In particular, in this case, it is more preferable that the liquid resin uses a polymer or oxide having a viscosity of 5 cp to 500 cp. In the case where the liquid resin is not used, the first and second grid patterns may be buried using a polymer or oxide by a vacuum deposition process.

Prior to the fourth process, a surface treatment process may be further performed on the first grid patterns or the second grid patterns by any one of an atmospheric pressure plasma treatment, a vacuum plasma treatment, a peroxide treatment, a pro-oxidant treatment, an anticorrosive treatment, and a self-assembly monolayer (SAM) coating. In this manner, the wire grid polarizer having the structure described above with reference to FIG. 5 may be manufactured.

While the invention has been shown and described with reference to exemplary embodiments thereof, it will be understood by those skilled in the art that various changes in form and details may be made therein without departing from the spirit and scope of the invention as defined by the appended claims. Therefore, the scope of the invention is defined not by the detailed description of the invention but by the appended claims, and all differences within the scope will be construed as being included in the present invention.

1-21. (canceled)

22. A wire grid polarizer comprising:
a first grid patterns on a substrate;
a second grid pattern on the first grid patterns; and
a passivation layer filling between the first grid patterns and the second grid patterns.

23. The wire grid polarizer of claim 22, wherein the second grid patterns are formed of metal.

24. The wire grid polarizer of claim 22, wherein the period of the first grid patterns or the second grid patterns ranges from 50 nm to 200 nm.

25. The wire grid polarizer of claim 22, wherein the substrate is a transparent substrate.

26. The wire grid polarizer of claim 22, wherein the passivation layer is formed of a polymer or an oxide.

27. The wire grid polarizer of claim 22, wherein the width of the first grid patterns ranges from 10 nm to 200 nm, and the height of the first grid patterns ranges from 10 nm to 500 nm.

28. The wire grid polarizer of claim 22, wherein the width to height ratio of the first grid patterns ranges from 1:0.2 to 1:5.

29. The wire grid polarizer of claim 22, wherein the second grid patterns are formed of any one metal selected from aluminum, chromium, silver, copper, nickel, and cobalt, or an alloy thereof.

30. The wire grid polarizer of claim 22, wherein the width ratio of the first grid patterns to the second grid patterns ranges from 1:0.2 to 1:1.5.

31. The wire grid polarizer of claim 22, wherein the width of the second grid patterns ranges from 2 nm to 300 nm.

32. The wire grid polarizer of claim 22, further comprising a surface treatment layer formed on the surface of the first grid patterns or the second grid patterns.

33. The wire grid polarizer of claim 32, wherein the surface treatment layer is any one of a plasma treatment layer, an organic or inorganic blackening layer, a peroxide treatment layer, a pro-oxidant treatment layer, an anticorrosive treatment layer, and a self-assembly monolayer (SAM) coating layer.

34. A wire grid polarizer comprising:
a passivation layer stacked on a substrate; and
one or more second grid patterns spaced apart from the surface of the substrate and buried within the passivation layer.

35. The wire grid polarizer of claim 33, wherein the second grid patterns are formed of metal.

36. The wire grid polarizer of claim 34, wherein the period of the second grid patterns ranges from 50 nm to 200 nm.

37. The wire grid polarizer of claim 34, wherein the substrate is a transparent substrate.

38. The wire grid polarizer of claim 34, wherein the passivation layer is formed of a polymer or an oxide.

39. The wire grid polarizer of claim 22, wherein the second grid patterns are formed of any one metal selected from aluminum, chromium, silver, copper, nickel, and cobalt, or an alloy thereof.

40. The wire grid polarizer of claim 34, wherein the width of the second grid patterns ranges from 2 nm to 300 nm.
